(19) United States
(12) Patent Application Publication
(10) Pub. No.: US 2008/0131353 A1
(43) Pub. Date: Jun. 5, 2008

(54) Methods For Purification Of Trimetallic Nitride Endohedral Metallofullerenes And Related Fullerene Derivatives

(75) Inventors: Harry W. Gibson, Blacksburg, VA (US); Harry C. Dorn, Blacksburg, VA (US); Zhongxin Ge, Blacksburg, VA (US); Ting Cai, Blacksburg, VA (US)

Correspondence Address: WHITHAM, CURTIS & CHRISTOFFERSON & COOK, P.C., 11491 SUNSET HILLS ROAD, SUITE 340, RESTON, VA, 20190, US

(73) Assignee: Virginia Polytechnic Institute and State University, Blackburg, VA (US)

(21) Appl. No.: 11/570,700

(22) PCT Filed: Jun. 23, 2005
(86) PCT No.: PCT/US2005/022386

§ 371 Date: Aug. 2, 2007

Related U.S. Application Data
(60) Provisional application No. 60/581,757, filed on Jun. 23, 2004.

(51) Int. Cl. C01B 31/00

(52) U.S. Cl. 423/461; 977/736; 977/840

(57) ABSTRACT

Methods for separating and purifying carbon nanomaterials such as trimetallic nitride endohedral metallofullerenes are described. In certain embodiments, carbon nanomaterials are contacted with a carbon nanomaterial reactive agent. The reactive agent binds empty cage fullerenes, nanotubes, and endohedral metallofullerenes without appreciably binding trimetallic nitride endohedral metallofullerenes. According to some embodiments, purified forms of trimetallic nitride endohedral metallofullerenes may be prepared.

### FIELD OF THE INVENTION

The invention relates to methods for purifying carbon nanomaterials such as trimetallic nitride endohedral metallofullerenes, endohedral metallofullerenes, fullerene derivatives, empty cage fullerenes, nanotubes, and other carbon nanomaterials in an efficient, simplified manner to yield isolated products of high purity.

### BACKGROUND OF THE INVENTION

Trimetallic nitride endohedral metallofullerenes possess a number of potentially useful biological, magnetic, electronic, and chemical properties. U.S. Pat. No. 6,303,760, herein specifically incorporated by reference, describes the preparation of a family of trimetallic nitride endohedral metallofullerenes. Generally, the trimetallic nitride endohedral metallofullerenes are prepared by arc-vaporization of graphite rods packed with one or more metal oxides in a Krätschmer-Huffman generator in the presence of a nitrogen-containing atmosphere. During the arc-vaporization process, a variety of carbon nanomaterials including the trimetallic nitride endohedral metallofullerenes are formed in a reaction soot.

Separation of the carbon nanomaterials typically has involved the extraction of the carbon nanomaterials from the soot followed by using chromatographic methods to separate each carbon nanomaterial. These methods are relatively time consuming and are not particularly convenient for large scale separations.

In WO98/09913, Rotello describes a method for separating fullerenes such as C₆₀, C₇₀, C₇₆, C₇₈, and C₈₄ from soot through covalent attachment of fullerenes to insoluble supports. The insoluble support with the fullerenes attached is removed, followed by cleaving the fullerenes from the support.

A method for easily and conveniently purifying trimetallic nitride endohedral metallofullerenes is desired.

### SUMMARY OF THE INVENTION

An exemplary embodiment of the invention is to provide a method for separating trimetallic nitride endohedral metallofullerenes in a single step. In this exemplary embodiment, soot containing a mixture of fullerenes, trimetallic nitride endohedral metallofullerenes, and other materials which may be generated by an electric arc or by other means is loaded onto a column which includes a support material modified with a reactive group, such as a cyclopentadiene, that will covalently bond to fullerenes. In this exemplary embodiment, the support material can be a polymeric resin such as Merrifield's polymer (commercially available from various suppliers such as Aldrich Chemical Co.), silica gel (commercially available from various suppliers such as Fisher Chemical), or other polymeric or resinous material, including but not limited to polystyrenes, polyacrylates, polymethacrylates, etc. However, it should be understood that a variety of solid supports may be used in the practice of this invention, and that the function of the support material is to allow a solution or dispersion containing fullerenes, fullerene derivatives, nanotubes, endohedral metallofullerenes, trimetallic nitride endohedral metallofullerenes and the like to pass over or through the support material, while presenting a reactive group at one or a plurality of locations which may covalently bond with fullerenes, fullerene derivatives, endohedral metallofullerenes, and nanotubes. In a preferred embodiment, cyclopentadienes are bonded as pendent groups to the backbone of the support material so as to interact with and covalently bond to the fullerenes, fullerene derivatives, endohedral metallofullerenes, and nanotubes. However, it should be understood that a wide variety of chemical constituents containing, for example, conjugated dienes or double or triple carbon-carbon bonds, can be used in the practice of this invention, including without limitation, anthracene, etc. The chief requirement of the chemically reactive group is that it is reactive towards fullerenes, endohedral metallofullerenes, and nanotubes, e.g., malonate esters and amides, or aldehydes in the presence of appropriate amines such as sarcosine. As will be discussed in detail below, dienes, such as cylopentadiene, furans, and anthracene, and other moieties which react by Diels-Alder processes may be particularly preferred reactive groups: however, any functional group reactive towards fullerenes, endohedral metallofullerenes, and nanotubes may be used in the practice of this invention. The solvent used to transport the fullerenes, fullerene derivatives, endohedral metallofullerenes, and/or nanotubes through or over the support material bearing the reactive groups can be wide ranging and is preferably a non-polar solvent such as toluene, carbon disulfide, 1,2-dichlorobenzene, or other chlorinated or fluorinated solvents known to practitioners in the art.

The inventors have discovered that fullerenes, fullerene derivatives, endohedral metallofullerenes, trimetallic nitride endohedral metallofullerenes, and nanotubes have different chemical reactivities with the chemically reactive group on the support. The chemical reactivities are quite variable and parameters such as the temperature of and flow rate through, for example, a column which contains the support material with the chemically reactive groups can be adjusted to effect easy separation of specific fullerene materials. In particular, in the first exemplary embodiment, it has been determined that trimetallic nitride endohedral metallofullerenes, such as for example, without limitation, Sc₃NC₈₀, Ho₃NC₈₀, Lu₃NC₈₀, Er₃NC₈₀, Gd₃NC₈₀, Gd₂ScNC₈₀, Tb₃NC₈₀, Dy₃NC₈₀, and other trimetallic nitride endohedral metallofullerenes, may be separated from a soot containing fullerenes C₆₀, C₇₀, C₇₆, C₇₈, and C₈₄ and endohedral metallofullerenes, at approximately room temperature and with contact times ranging from about 2 minutes to about 24 hrs with the support material bearing the reactive groups. The fullerenes and endohedral metallofullerenes, covalently bond to the chemically reactive groups on the support material and are retained in the reaction column, while the trimetallic nitride endohedral metallofullerenes pass through the reactive column and are collected in substantially pure form free of fullerene and endohedral metallofullerenes.

In a second exemplary embodiment, the inventors have recognized that fullerenes, fullerene isomers, endohedral metallofullerenes, and fullerene derivatives, as well as nanotubes can be selectively purified using the above described support material which possess chemically reactive groups by taking advantage of the different rates of reaction between these species with the support and chemically reactive group. These species may be isolated by altering the temperature and flow conditions through the column containing the material, or by preferentially withdrawing solution or dispersion containing fullerenes at different locations in the column, or by other means.

### BRIEF DESCRIPTION OF THE DRAWINGS

FIG. 1 is a diagrammatic view of an embodiment of a carbon nanomaterial reactive column used for purifying endohedral metallofullerenes.

FIG. 2(a) is an HPLC trace of crude extract of scandium soot.

FIG. 2(b) is an HPLC trace of the eluent from the scandium soot.

FIG. 2(c) is an HPLC trace of the eluent after the fullerene reactive agent was exposed to maleic anhydride.

FIG. 3(a) is an HPLC trace of crude lutetium soot.

FIG. 3(b) is and HPLC trace of the eluent from the lutetium soot.

FIG. 4 is a series of HPLC traces (a)-(h) taken initially and at 30 minutes intervals following successive additions of the cyclopentadienyl-functionalized resin to empty cage fullerenes in toluene.

### DETAILED DESCRIPTION OF PREFERRED EMBODIMENTS OF THE INVENTION

Methods for increasing the purity of carbon nanomaterials such as trimetallic nitride endohedral metallofullerenes, endohedral metallofullerenes, fullerene derivatives, empty cage fullerenes, nanotubes, and other carbon nanomaterials are described. The various methods described below utilize the widely different rates of reaction of empty cage fullerenes, fullerene derivatives, nanotubes, endohedral metallofullerenes, and trimetallic endohedral metallofullerenes with a carbon nanomaterial reactive agent. In many instances, the rates of reaction are different enough to allow them to be selectively separated. Further, the rate of reaction for different isomers of a species, in some instances, allow for the separation of particular isomers.

Carbon nanomaterials include, but are not limited to empty-cage fullerenes, nanotubes, endohedral metallofullerenes, trimetallic nitride endohedral metallofullerenes, or combinations thereof. Empty-cage fullerene products may include, but are not limited to, C₆₀, C₇₀, C₇₆, C₇₈, and C₈₄. When one or more metal oxides are used in the arc-vaporization process, in addition to empty-cage fullerenes and nanotubes, the carbon nanomaterials may also include one or more classic endohedral metallofullerenes like M₂@C₈₂ and M₂@C₈₄, where M is a metal from the metal oxide used in the arc-vaporization process (“endohedral metallofullerenes”). Further, if nitrogen is introduced into the arc-vaporization process, in addition to the empty-cage fullerenes, nanotubes, and endohedral metallofullerenes, the carbon nanomaterials may include one or more trimetallic nitride endohderal metallofullerenes having the general formula M₃₋ₙXₙN@Cₘ, where M is a metal, X is a second trivalent metal from a second metal oxide used in the arc-vaporization process, n is an integer from 0-3, and m is an even integer from about 60 to about 200 (“trimetallic nitride endohderal metallofullerene”). M and X may be a rare earth element, a group II element, a group III element, or a group IV element. Further, M and X may be lutetium, yttrium, erbium, europium, holmium, gadolinium, terbium, dysprosium, or uranium. M and X may be the same or different elements.

The reaction soot containing the carbon nanomaterials may be material directly obtained from the arc-vaporization process, or the reaction soot may be an extract of the soot generated from the arc-vaporization process, “soot extract.” For example, soot generated from the arc-vaporization process may be extracted with solvents such as toluene, carbon disulfide, 1,2-dichlorobenzene, xylene, decahydronapthalene, chlorinated solvents, fluorinated solvents, or other similar solvents useful for extraction of carbon nanomaterials to form a soot extract which contains one or more of the various carbon nanomaterials discussed above.

As will be described in detail below, trimetallic nitride endohedral metallofullerenes may be selectively removed from other carbon nanomaterials in the reaction soot by contacting the reaction soot with a carbon nanomaterial reactive agent. In certain embodiments, the carbon nanomaterial reactive agent contains reactive moieties which bind one or more of empty cage fullerenes, nanotubes, and endohedral metallofullerenes from the reaction soot, but do not appreciably bind the trimetallic nitride endohedral metallofullerenes. By selectively binding the empty cage fullerenes, nanotubes, and endohedral metallofullerenes, the trimetallic nitride endohedral metallofullerenes may be selectively separated from the other carbon nanomaterials. This feature takes advantage of the relatively fast rates of reaction of the fullerenes, nanotubes, and endohedral metallofullerenes with the carbon nanomaterial reactive agent compared to a very slow rate of reaction for the trinitride endohedral metallofullerenes.

To further illustrate the difference in rates of reactions Table I provides differences in relative reactivity between selected carbon nanomaterials. As can be seen in Table I, C₆₀, an empty cage fullerene, reacts very rapidly compared to the trimetallic nitride endohedral metallofullerenes, Gd₃N@C₈₀(Iₕ), Sc₃N@C₈₀(Iₕ), Sc₃N@C₈₀(D₅ₕ), and LU₃N@C₈₀.

TABLE I
Relative Rates of Reaction of Fullerenes
with Cyclopentadienyl Resin*

| | | |
|---|---|---|
| Carbon Nanomaterial | t_{1/2}** | Relative Rate |

| | | | |
|---|---|---|---|
| C₆₀ | 3.0 | min | 6.2 × 10⁴ |
| Gd₃N@C₈₀(Iₕ) | 11.5 | days | 11 |
| Sc₃N@C₈₀(Iₕ) | 80 | days | 1.6 |
| Sc₃N@C₈₀(D₅ₕ) | 3.1 | days | 42 |
| Lu₃N@C₈₀ | 1.3 × 10² | days | 1 |

*6.0 mL of 37 mM M₃N@C₈₀ in toluene with 0.50 g (0.50 mmol) of ground resin, well stirred, 25° C.
**t_{1/2} = time for one-half of the fullerene to be reacted. Estimated error ±20%.

Accordingly, by controlling the amount of time the carbon nanomaterials are in contact with the carbon nanomaterial reactive agent, unbound carbon nanomaterials may be easily removed and isolated by an appropriate solvent.

In some embodiments, a collection solvent may be used to remove or wash unreacted trimetallic nitride endohedral metallofullerenes away from the carbon nanomaterial reactive agent. The collection solvent may include, but is not limited to, toluene, carbon disulfide, 1,2-dichlorobenzene, xylene, decahydronapthalene, chlorinated solvents, fluorinated solvents, or other similar solvents useful for extracting carbon nanomaterials. After removing the unreacted trimetallic nitride endoheral metallofullerenes away from the fullerene reactive agent, the collection solvent contains purified trimetallic nitride endohedral metallofullerenes.

The reaction soot containing carbon nanomaterials is brought into contact with a carbon nanomaterial reactive agent. The carbon nanomaterial reactive agent comprises a support having carbon nanomaterial reactive moieties. The support is not particularly limited, and may include any solid or soluble resinous or oxide support, except that the support should have carbon nanomaterial reactive moieties inherently, or through a reaction with a carbon nanomaterial reactive precursor to produce a carbon nanomaterial reactive moiety on the support. Examples of supports may include but are not limited to, Merrifield's resins, 4-benzyloxybenzyl bromide resin, Wang resin, brominated Wang resin, Wang amide resin, PAM resin, aminomethyl polystyrene, HMPPA-MBHA resin, chloromethylated styrene-divinylbenzene copolymer, chloropropyl functionalized silica gel, polystyrene, polyacrylates, or polymethacrylates, or other functionalized polymers and copolymers commercially available to, or prepared by, those skilled in the art. Further, the support may include functionalized inorganic oxides including, but not limited to, functionalized silica, alumina, titania, or zirconia.

If the solid support does not inherently have a carbon nanomaterial reactive moiety, the solid support should be able to form a carbon nanomaterial reactive moiety when exposed to a carbon nanomaterial reactive precursor. The carbon nanomaterial reactive precursor is a reagent that will form a carbon nanomaterial reactive moiety when reacted with the support. For example, to form a cyclopentadienyl carbon nanomaterial reactive precursor on a chloromethylated styrene-divinylbenzene copolymer (a Merrifield resin), a cyclopentadienyl salt like sodium cylopentadienylide may be reacted with the copolymer to form the carbon nanomaterial reactive moiety on the polymer support.

In certain embodiments, the carbon nanomaterial reactive moiety may be a functional group on the support that is able to react with and bind empty cage fullerenes and/or nanotubes. In certain embodiments, the carbon nanomaterial reactive moiety is able to react with and bind endohedral metallofullerenes. In other embodiments, the carbon nanomaterial reactive moiety reversibly binds empty cage fullerenes, nanotubes, and/or endohedral metallofullerenes. In some embodiments, the carbon nanomaterial reactive moiety does not appreciably react with or bind trimetallic nitride endohedral metallofullerenes. In certain embodiments, the carbon nanomaterial reactive moiety is a functional group that is able to react by cycloaddition with empty-cage fullerenes and/or nanotubes. In other embodiments, the carbon nanomaterial reactive moiety is able to react by cycloaddition with endohedral metallofullerenes. The carbon nanomaterial reactive moiety may be a reactive group that contains a conjugated diene that can form cycloaddition reaction products with empty cage fullerenes, nanotubes, and/or metal encapsulated fullerenes. Examples of carbon nanomaterial reactive moieties may include, but are not limited to, cyclopentadienyl, anthracenyl, malonate esters, malonamides, furans, fulvenes, azadienes, enones, quinodimethanes and their precursors, amines, azides, carbenes, or azomethineylides.

In certain embodiments, the carbon nanomaterial reactive agent exhibits different rates of reaction with the different carbon nanomaterials. In some embodiments, the carbon nanomaterial reactive agent reacts with empty cage fullerenes at room temperature in less than 120 min, while not substantially reacting with trimetallic nitride endohedral metallofullerenes for a period of 1 or more days. By utilizing the relative rates of reaction between the various carbon nanomaterials and the carbon nanomaterial reactive agent, isolation or purification of any one of the selected carbon nanomaterials may be realized. Further, where different isomers for a carbon nanomaterial exist, if the rate of reaction between the different isomers and the carbon nanomaterial reactive agent is sufficiently different, the different isomers may also be separated.

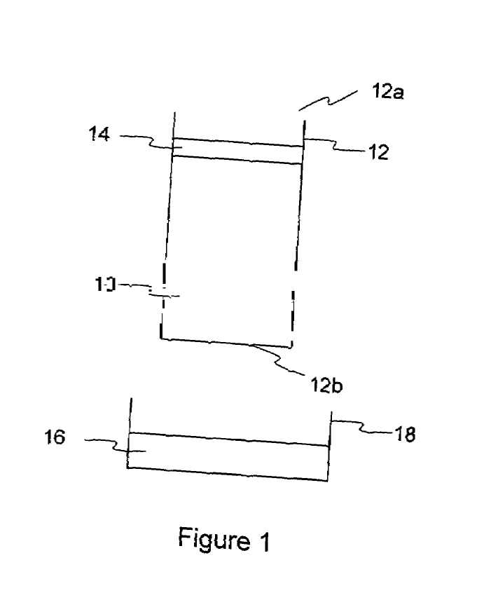

The carbon nanomaterial reactive agent may be used in a variety of ways to increase the purity of trimetallic nitride endohedral metallofullerenes. For example, as illustrated in FIG. 1, carbon nanomaterial reactive agent 10 may be placed in a reaction column 12 and the reaction soot 14 containing the carbon nanomaterials placed in contact with the carbon nanomaterial reactive agent in the reaction column. Depending upon the support and carbon nanomaterial reactive moiety utilized, the reaction soot should remain in contact with the carbon nanomaterial reactive agent for a time sufficient to bind the carbon nanomaterials and not appreciably bind trimetallic endohedral metallofullerenes. In certain embodiments, this time may range from about 2 min to about 24 hours and may vary depending upon such variables as the support, the temperature, the solvent, the carbon nanomaterial reactive moiety, and the composition of the carbon nanomaterial. Generally, the temperature of the process should be kept below the boiling point of the solvent being used. In many situations, the temperature may range from about 200K to about 450K. In other embodiments, the temperature may range from about 290K to about 400K.

After sufficient contact with the carbon nanomaterial reactive agent, unreacted trimetallic nitride endohedral metallofullerenes may be removed away from the reactive agent by washing the reactive agent with a suitable solvent. Suitable solvents may include but are not limited to toluene, carbon disulfide, 1,2-dichlorobenzene, xylene, decahydronapthalene, chlorinated solvents, fluorinated solvents, or other similar solvents useful for extracting trimetallic nitride endohedral metallofullerenes. Similarly, the bound carbon nanomaterial has been selectively removed from the soot or soot extract. As will be discussed below, the bound carbon nanomaterials may also be removed from the resin and isolated.

In other embodiments solvent may be introduced at the first end 12a of the reaction column and collected at the second end 12b of the reaction column with a collection device 18. The collected solvent 16 will contain purified trimetallic nitride endohedral metallofullerenes. The flow rate of the solvent through the reaction column should be a rate that will provide sufficient time for binding between the carbon nanomaterial reactive agent and one or more of empty cage fullerenes, nanotubes, endohedral metallofullerenes. The flow rate will vary widely depending upon the temperature, solvent, size of the column, the carbon nanomaterial reactive agent, the amount and composition of the carbon nanomaterial. In certain embodiments, the flow rate is typically 10 ml/hour and provides a separation time ranging from about 2 min to about 24 hours.

In another embodiment, a solid or soluble carbon nanomaterial reactive agent may be added to a soot extract solution containing carbon nanomaterials. After allowing the carbon nanomaterial reactive agent to remain in contact with the soot extract for a sufficient period of time to allow binding of the empty-cage fullerenes, the solution containing the unreacted carbon nanomaterial, such as the trimetallic nitride endohedral metallofullerenes, may be removed. When a solid carbon nanomaterial reactive agent is used, the soot extract may be filtered, removing the solid carbon nanomaterial reactive agent, leaving only the solution containing unreacted carbon nanomaterial. When a soluble carbon nanomaterial reactive agent is used, the soluble reactive agent may be solvent precipitated out of solution, followed by filtering to leave a solution containing unreacted carbon nanomaterial.

When the trimetallic nitride endohedral metallofullerenes have been selectively separated from other carbon nanomaterials, the trimetallic nitride endohedral metallofullerenes are in a purified form. In some embodiments, the endohedral metallofullerenes may be above about 90% pure relative to other fullerene reaction products. In certain other embodiments, the endohedral metallofullerenes are above about 98% pure. The solvent may be removed to provide a composition of trimetallic nitride endohedral metallofullerenes that is above 90% pure, and in some embodiments above 98% pure.

As discussed above, isomers for different carbon nanomaterials may be separated provided that the isomers exhibit different rates of reaction with the carbon nanomaterial reactive agent. For example, as shown in Table I, Sc₃N@C₈₀ (Iₕ) exhibits a relative t_{1/2} on the order of 80 or more days as compared to Sc₃N@C₈₀ (D₅ₕ) having a t_{1/2} of about 3 days with cyclopentadienyl resin in toluene at 25° C., more than 25-fold difference. This difference in relative reactivity allows for the separation of different isomers of trimetallic nitride endohedral metallofullerenes. For example, a soot extract containing the isomers may be contacted with a carbon nanomaterial reactive agent for a time less than is required to appreciably bind the less reactive isomers. The unbound isomers may be removed away from the carbon nanomaterial reactive agent by a suitable solvent. The resultant purified isomers may then again be brought into contact with a carbon nanomaterial reactive agent for a time sufficient to bind one isomer but not appreciably bind the other isomer, thus effectively separating the two isomers due to their difference in reactivity with the carbon nanomaterial reactive agent. The same approach may be utilized to separate other fullerenes or isomers in other fullerenes that have different rates of reaction with the carbon nanomaterial reactive agent, for example, the isomers of C₈₄.

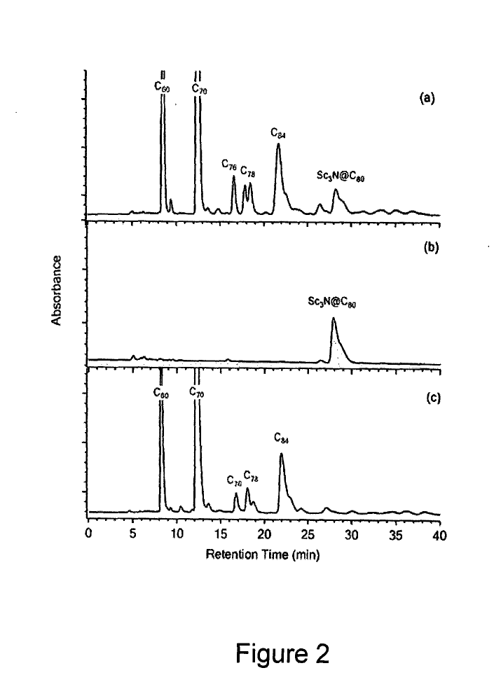

In addition to the separation of the trimetallic nitride endohedral metallofullerenes discussed above, a similar approach may be employed by using the different rates of reaction of C₆₀, C₇₀, C₇₈, C₈₄, and their isomers, to selectively separate these fullerenes from one another. For example, certain isomers of C₇₈ and C₈₄ are less reactive than other fullerenes and can be separated from a mixture of fullerenes; see FIG. 2(c).

In some embodiments, carbon nanomaterials bound to the carbon nanomaterial reactive agent may be selectively removed from the reactive agent. For example, if the carbon nanomaterial reactive moiety reversibly binds the carbon nanomaterials, a carbon nanomaterial release agent may be used to remove the bound carbon nanomaterials from the reactive agent. Examples of reversibly binding of the carbon nanomaterials include, but are not limited to, 4+2 cycloaddition reactions, such as Diel Alders reaction mechanisms, 3+2 cycloadditions, 2+1 cycloadditions, and other similar reversible reaction mechanisms. By removing the bound carbon nanomaterial, the reactive agent may be regenerated for reuse in purifying trimetallic nitride endohedral metallofullerenes. Such reversible aspects can play an important role in commercial recovery processes.

In certain embodiments, the resin containing bound carbon nanomaterial may be placed in contact with a release agent that is typically more reactive than the bound carbon nanomaterial. Depending upon the reaction kinetics of the release agent relative to the bound carbon nanomaterial, the mixture may be heated to release the bound carbon nanomaterials. For example, in certain embodiments the empty cage fullerenes and endohedral metallofullerenes may be removed from the reactive agent by adding a carbon nanomaterial release reagent that will react with reactive moieties and displace the bound empty cage fullerenes and metal encapsulated fullerenes. In some embodiments, the reactive agent is heated to a temperature ranging from about 50° C. to a temperature that is less than the boiling point of the solvent being used with the reactive agent. Upon release of the fullerenes, the fullerenes may be eluted with solvent and collected. In certain other embodiments, the empty cage fullerenes are displaced from the reactive agent at different rates, thus allowing the isolation of empty cage fullerenes. The fullerene release reagent is any reagent that more strongly bind to the fullerene reactive moieties than the fullerene products. Examples of a fullerene release reagent include, but are not limited to, maleic anhydride, maleimides, N-sulfinyl compounds, nitroso compounds, acylnitroso compounds, cyanoolefins, and combinations thereof.

### EXAMPLES

### Cyclopentadiene-Functionalized Resin

A suspension of chloromethylated styrene-divinylbenzene copolymer (1% cross-linked, 3.5-4.5 mequiv of Cl/g) in toluene was cooled to 20° C. To this suspension, sodium cyclopentadienylide was added dropwise. The mixture was stirred for 2 hours at 20° C., filtered and washed with toluene to give a dark brown cyclopentadiene-functionalized resin.

### Purification of Sc₃N@C₈₀ Using a Cyclopentadiene-Functionalized Resin

Soot extract containing C₆₀, C₇₀, C₇₆, C₇₈, C₈₄, and Sc₃N@C₈₀ in toluene was passed through a column packed with excess cyclopentadiene-functionalized resin as the fullerene reactive agent. The eluent was collected during a 48 hour period at a rate of 6 ml/hour at room temperature. FIG. 2a shows the HPLC analysis of the soot extract prior to contact with the fullerene reactive agent. The HPLC analysis clearly shows peaks for C₆₀, C₇₀, C₇₆, C₇₈, C₈₄, and Sc₃N@C₈₀. FIG. 2b shows and HPLC analysis of the eluent that was collected during the 48 hour period. The HPLC analysis shows that the only substantial fullerene product is Sc₃N@C₈₀.

Maliec anhydride was added to the column which was then heated at 85° C. overnight. The column was eluted with toluene. FIG. 2c shows the HPLC analysis of the eluted fullerene products.

### Purification of Lu₃N@₈₀ Using a Cyclopentadiene-Functionalized Resin

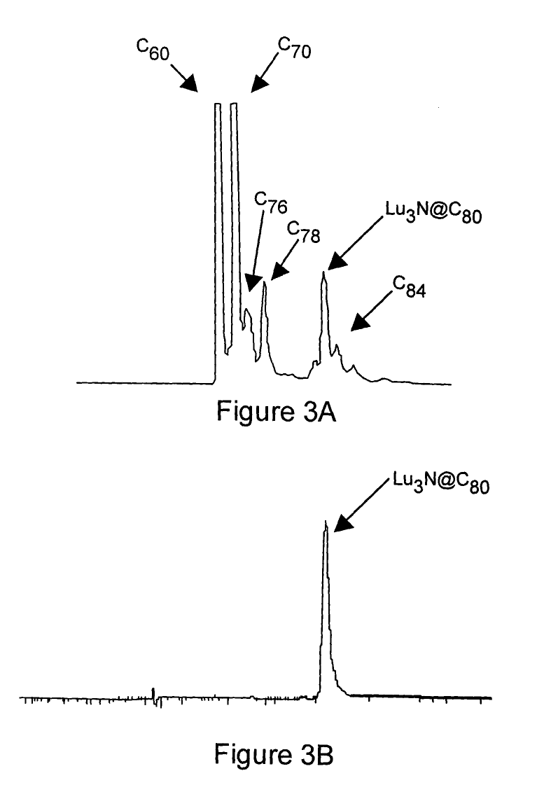

Soot extract containing C₆₀, C₇₀, C₇₆, C₇₈, C₈₄, Lu₂@C₈₂, Lu₂@C₈₄, and Lu₃N@C₈₀ in toluene was passed through a column packed with excess cyclopentadiene-functionalized resin as the fullerene reactive agent. The eluent was collected during a 4 hour period. FIG. 3a shows the HPLC analysis of the soot extract prior to contact with the fullerene reactive agent. The HPLC analysis clearly shows peaks for C₆₀, C₇₀, C₇₆, C₇₈, C₈₄, Lu₂@C₈₂, Lu₂@C₈₄, and Lu₃N@C₈₀. FIG. 3b shows and HPLC analysis of the eluent that was collected during the 4 hour period. The HPLC analysis shows that the only substantial fullerene product is Lu₃N@C₈₀.

### Purification of Gd₃N@C₈₀ Using a Cyclopentadiene-Functionalized Resin

Soot extract containing C₆₀, C₇₀, C₇₆, C₇₈, C₈₄, and Gd₃N@C₈₀ in toluene is passed through a column packed with excess cyclopentadiene-functionalized resin as the fullerene reactive agent. The eluent is collected during about a 1 hour period at a rate of about 10 ml/hour at room temperature. The only substantial fullerene product is Gd₃N@C₈₀.

### Purification of Ho₃N@C₈₀ Using a Cyclopentadiene-Functionalized Resin

Soot extract containing C₆₀, C₇₀, C₇₆, C₇₈, C₈₄, and Ho₃N@C₈₀ in toluene is passed through a column packed with excess cyclopentadiene-functionalized resin as the fullerene reactive agent. The eluent is collected during about a 1 hour period at a rate of about 10 ml/hour at room temperature. The only substantial fullerene product is Ho₃N@C₈₀.

### Reactions of Cyclopentadiene-Functionalized Resin and Empty-Cage Fullerenes

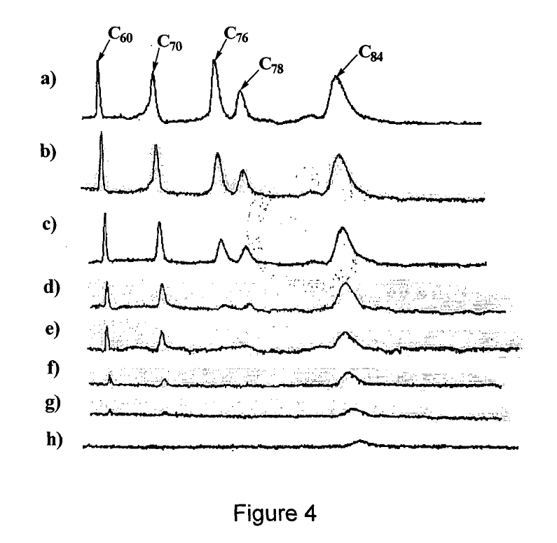

Small amounts of cyclopentadiene-functionalized resin were added to a mixture of C₆₀, C₇₀, C₇₆, C₇₈, and C₈₄ in toluene at room temperature on half hour intervals. The mixture was monitored by HPLC at each interval. FIG. 4(a) is a chromatogram of the initial mixture showing all empty cage fullerene species. All empty cage fullerenes are present. FIG. 4(b) is a chromatogram 30 minutes after 4 mg of resin were added to the mixture. Peaks for C₇₆ and C₇₈ begin to disappear first. FIG. 4(c) is a chromatogram 30 minutes after another 4 mg of resin were added to the mixture. FIG. 4(d) is a chromatogram 30 minutes after 10 mg of resin were added to the mixture. Peaks for C₇₆ and C₇₈ are almost gone. FIG. 4(e) is a chromatogram 30 minutes after 4 mg of resin were added to the mixture. Peaks for C₆₀, C₇₀, and C₈₄ remain. FIG. 4(f) is a chromatogram 30 minutes after 4 mg of resin were added to the mixture. Peaks for C₆₀ and C₇₀ are decreasing. FIG. 4(g) is a chromatogram 30 minutes after 4 mg of resin were added to the mixture and shows small amounts of C₆₀, C₇₀, and C₈₄. FIG. 4(h) is a chromatogram 30 minutes after 2 mg of resin were added to the mixture. From FIGS. 4(b)-(h), it can be seen that C₇₆ and C₇₈ disappear first followed by C₆₀ and C₇₀, and then finally C₈₄.

### Cyclopentadiene-Substituted Silica

To a solution of lithium cyclopentadienylide in THF at room temperature under nitrogen, 3-chloropropyl functionalize silica gel was added in one portion. The mixture was stirred at room temperature for 24 hours, filtered, and washed with THF to give a light yellow cyclopentadiene substituted silica gel.

### Purification of Sc₃N@C₈₀ Using a Cyclopentadiene-Substituted Silica and

Soot extract containing C₆₀, C₇₀, C₇₆, C₇₈, C₈₄, and Sc₃N@C₈₀ in toluene is passed through a column packed with excess cyclopentadiene-substituted silica as the fullerene reactive agent. The eluent is collected during about a 1 hour period at a rate of about 10 ml/hour at room temperature. The only substantial fullerene product in the eluent is Sc₃N@C₈₀.

### Purification of Lu₃N@C₈₀ Using Cyclopentadiene-Substituted Silica

Soot extract containing C₆₀, C₇₀, C₇₆, C₇₈, C₈₄, Lu₂@C₈₂, Lu₂@C₈₄, and Lu₃N@C₈₀ in toluene is passed through a column packed with excess cyclopentadiene-substituted silica as the fullerene reactive agent. The eluent is collected during about a 1 hour period at a rate of about 10 ml/hour at room temperature. The only substantial fullerene product eluted is Lu₃N@C₈₀.

### Purification of Gd₃N@C₈₀ Using Cyclopentadiene-Substituted Silica

Soot extract containing C₆₀, C₇₀, C₇₆, C₇₈, C₈₄, and Gd₃N@C₈₀ in toluene is passed through a column packed with excess cyclopentadiene-substituted silica as the fullerene reactive agent. The eluent is collected during about a 1 hour period at a rate of about 10 ml/hour at room temperature. The only substantial fullerene product is Gd₃N@C₈₀.

### Purification of Ho₃N@C₈₀ Using Cyclopentadiene-Substituted Silica

Soot extract containing C₆₀, C₇₀, C₇₆, C₇₈, C₈₄, and Ho₃N@C₈₀ in toluene is passed through a column packed with excess cyclopentadiene-substituted silica as the fullerene reactive agent. The eluent is collected during about a 1 hour period at a rate of 10 ml/hour at room temperature. The only substantial fullerene product is Ho₃N@C₈₀.

What is claimed is:

1. A method for increasing the purity of trimetallic nitride endohedral metallofullerenes, comprising the steps of:
contacting reaction soot containing trimetallic nitride endohedral metallofullerenes with a carbon nanomaterial reactive agent;
binding empty cage fullerenes to the carbon nanomaterial reactive agent; and
removing unbound trimetallic nitride endohedral metallofullerenes from the carbon nanomaterial reactive agent.

2. The method of claim 1, wherein the step of removing unbound trimetallic nitride endohedral metallofullerenes comprises the steps of washing the carbon nanomaterial reactive agent with a solvent and collecting the solvent containing trimetallic nitride endohedral metallofullerenes.

3. The method of claim 1, wherein the carbon nanomaterial reactive agent comprises a carbon nanomaterial reactive moiety bound to a support, and wherein the carbon nanomaterial reactive moiety binds empty cage fullerenes during the binding empty cage fullerene step.

4. The method of claim 3, wherein the support is silica.

5. The method of claim 3, wherein the support is styrene-divinylbenzene copolymer.

6. The method of claim 3, wherein the carbon nanomaterial reactive moiety is selected from the group consisting of cyclopentadienyl, anthracenyl, malonate esters, malonamides, furans, fulvenes, azadienes, enones, quinodimethanes and their precursors, amines, azides, carbenes, and azomethine ylides.

7. The method of claim 1, further comprising the step of binding endohedral metallofullerenes to the carbon nanomaterial reactive agent.

8. The method of claim 1, further comprising the step of removing the solvent from the trimetallic nitride endohedral metallofullerene.

9. A method for removing trimetallic nitride endohedral metallofullerenes from soot, comprising the steps of:
contacting soot containing trimetallic nitride endohedral metallofullerenes with a carbon nanomaterial reactive agent, the carbon nanomaterial reactive agent comprising a carbon nanomaterial reactive moiety bound to a support, wherein the carbon nanomaterial reactive moiety is a cyclopentadienyl moiety;
binding empty cage fullerenes and metal encapsulated fullerenes to the carbon nanomaterial reactive agent;
washing the carbon nanomaterial reactive agent with a solvent to remove unbound trimetallic nitride endohedral metallofullerenes; and
collecting the solvent containing trimetallic nitride endohedral metallofullerenes.

10. The method of claim 9, wherein the support is silica.

11. The method of claim 9, wherein the support is styrene-divinylbenzene copolymer.

12. The method of claim 9, further comprising the step of removing the solvent from the trimetallic nitride endohedral metallofullerenes.

13. A method for removing empty cage fullerenes from trimetallic nitride endohedral metallofullerenes, comprising the steps of:
contacting reaction soot containing trimetallic nitride endohedral metallofullerenes and empty cage fullerenes with a carbon nanomaterial reactive agent;
binding empty cage fullerenes to the carbon nanomaterial reactive agent;
removing unbound trimetallic nitride endohedral metallofullerenes from the carbon nanomaterial reactive agent;
after removing the trimetallic nitride endohedral metallofullerenes from the carbon nanomaterial reactive agent, adding a fullerene release agent to the carbon nanomaterial reactive agent, wherein the fullerene release agent displaces the empty cage fullerenes from the carbon nanomaterial reactive agent; and
washing the displaced empty cage fullerenes from the carbon nanomaterial reactive agent.

14. The method of claim 13, wherein the fullerene release agent is maleic anhydride.

15. A method of separating one or more fullerenes, fullerene derivatives, and nanotubes from a soot containing a plurality of fullerenes, fullerene derivatives, and nanotubes, comprising the steps of:
adding a reaction soot containing a plurality of fullerenes, fullerene derivatives, and nanotubes to a reaction column containing a support material having a carbon nanomaterial reactive moiety chemically bonded thereto, said carbon nanomaterial reactive agent having a different rates of reaction for one or more fullerenes, fullerene derivatives or nanotubes of interest relative to other fullerenes, fullerene derivatives or nanotubes;
exposing said reaction soot to said carbon nanomaterial reactive agent for a time and at a temperature sufficient to achieve covalent bonding between said fullerene reactive agent and said other fullerenes, fullerene derivatives or nanotubes, without covalently bonding said one or more fullerenes, fullerene derivative, and nanotubes of interest; and
recovering said one or more unbonded fullerenes, fullerene derivatives, and nanotubes of interest from said reaction column.

16. The method of claim 15 wherein said exposing step includes the step of increasing a temperature of said reaction column.

17. The method of claim 15 wherein said exposing step includes the step of decreasing a temperature of said reaction column.

18. The method of claim 15 wherein said recovering step is performed at a bottom of said reaction column.

19. The method of claim 15, further comprising the step of isolating bonded fullerenes, fullerene derivatives or nanotubes from the reaction soot.
